(19) United States
(12) Patent Application Publication
(10) Pub. No.: US 2026/0254144 A1
(43) Pub. Date: Aug. 27, 2026

(54) ELECTRICAL INTERPOSER

(71) Applicant: Samtec, Inc., New Albany, IN (US)

(72) Inventors: Daniel R. BIRCH, New Albany, IN (US); Troy B. HOLLAND, New Albany, IN (US)

(21) Appl. No.: 18/881,957

(22) PCT Filed: Jul. 7, 2023
(86) PCT No.: PCT/US2023/027092

§ 371 Date: Jan. 7, 2025

Related U.S. Application Data
(60) Provisional application No. 63/359,617, filed on Jul. 8, 2022.

(51) Int. Cl. H01R 13/24; H01R 13/11; H01R 24/50; H01R 103/00

(52) U.S. Cl. CPC H01R 13/2407; H01R 13/111; H01R 24/50; H01R 2103/00

(57) ABSTRACT

An electrical interposer includes an electrical conductor, an inner wall that circumscribes the electrical conductor, an outer wall that circumscribes the inner wall, and a connecting structure provided between the inner wall and the outer wall.

### CROSS REFERENCE TO RELATED APPLICATIONS

This application claims the benefit of U.S. Patent Application No. 63/359,617 filed on Jul. 8, 2022. The entire contents of this application are hereby incorporated by reference.

### BACKGROUND OF THE INVENTION

### 1. Field of the Invention

The present invention generally relates to interposers for electrical connectors, in particular, to interposers for radio-frequency (RF) or coaxial-board connectors.

### 2. Description of the Related Art

Known coaxial connectors are typically large, complicated structures usually based on insertion of a center conductor into a cylindrical housing. Accordingly, size reduction (miniaturization) and high data rates are significantly limited by known coaxial connectors.

### SUMMARY OF THE INVENTION

Interposers according to embodiments of the present invention can be manufactured by an additive manufacturing process, with selective metallization applied to portions of the interposers. In particular, an interior conductor and an exterior conductor of the interposers are able to be provided with conductive coatings, while an insulator is able to be located between an interior shell or wall of the interior conductor and an exterior shell or wall of the exterior conductor. The insulator can be manufactured with a non-solid structure, such as a lattice structure, that can reduce dielectric constant and loss. The lattice structure can securely locate the interior conductor, while also providing elasticity, when the interposers are compressed. The interposer can be used for RF applications, as solder ball replacements, etc.

An electrical interposer can include one or more of an electrical conductor, an inner wall that can circumscribe the electrical conductor and that can include an outer surface and an inner surface, an outer wall that can circumscribe the inner wall and that can include an outer surface and an inner surface, and a connecting structure between the inner wall and the outer wall.

Each of the inner wall and the outer wall can have or define a tubular shape. The inner wall and the outer wall can be concentric or can define a concentric shape. The connecting structure can be not electrically conductive or electrically non-conductive. The electrical conductor can be defined by a lattice structure that can further include void spaces and struts that can extend from the outer surface of the inner wall. The connecting structure can be defined by a lattice structure that can include void spaces and struts that can extend from and between the outer surface of the inner wall and the inner surface of the outer wall.

The electrical conductor can include an opening that receives a mating conductor. Each of the electrical conductor, the inner wall, the outer wall, and the connecting structure can include or contain a same material. The material or the same material of each of the electrical conductor, the inner wall, the outer wall, and the connecting structure can include a 3D-printed material. The electrical conductor can include an electrically conductive coating. The inner surface of the inner wall can include an electrically conductive coating. The outer surface of the outer wall can include an electrically conductive coating. The struts can be arranged in a twisted pattern or in a radial, spiral pattern. The electrical conductor and the inner wall can twist, independently or as a single unit, when the electrical interposer is compressed. The electrical conductor can include an opening configured to receive a mating conductor. The electrical conductor can include teeth that are configured to engage the mating conductor when the electrical interposer receives the mating conductor.

A twinaxial electrical interposer comprising can include one or more of a first electrical conductor, a first inner wall that can circumscribe the first electrical conductor and that can include an outer surface and an inner surface, a second electrical conductor, a second inner wall that can circumscribe the second electrical conductor and that can include or define an outer surface and an inner surface, an outer wall that can include a first outer wall and a second outer wall. The first outer wall can circumscribe or at least partially circumscribe the first inner wall that can include an outer surface and an inner surface. The second outer wall can circumscribe or at least partially circumscribe the second inner wall that can include an outer surface and an inner surface. A first connecting structure can be between the first inner wall and the first outer wall. A second connecting structure can be between the second inner wall and the second outer wall.

Each of the first inner wall, the second inner wall, the first outer wall, and the second outer wall can define or have a tubular shape. The first inner wall and the first outer wall can be concentric or define a concentric shape, and the second inner wall and the second outer wall can be concentric or define a concentric shape. The first and the second connecting structures can be not electrically conductive or electrically non-conductive. The first electrical conductor can define or be defined by a lattice structure that can further includes void spaces and struts that extend from the outer surface of the first inner wall and the second electrical conductor can define or be defined by a lattice structure that can include void spaces and struts that can extend from the outer surface of the second inner wall. The first connecting structure can be defined by a lattice structure that can include or define void spaces and first struts that can extend from and between the outer surface of the first inner wall and the inner surface of the first outer wall. The second connecting structure can be defined by a lattice structure that can further include or define void spaces and second struts that can extend from and between the outer surface of the second inner wall and the inner surface of the second outer wall. The first electrical conductor can include an opening that receives a first mating conductor, and the second electrical conductor can include an opening that receives a second mating conductor.

Each of the first and the second electrical conductors, the first and the second inner walls, the outer wall, and the first and the second connecting structures can include or can contain a same material. The material or the same material of each of the first and the second electrical conductors, the first and the second inner walls, the outer wall, and the first and the second connecting structures can include a 3D-printed material. The first and the second electrical conductors can include, singularly or both, an electrically conductive coating. The inner surface of the first inner wall can include an electrically conductive coating. The inner surface of the second inner wall can include an electrically conductive coating. The outer surface of the first outer wall can include an electrically conductive coating. The outer surface of the second outer wall can include an electrically conductive coating.

The first and the second struts can each be arranged in a twisted pattern or in a radial, spiral pattern. The first electrical conductor and the first inner wall, individually or in tandem, can twist when the twinaxial electrical interposer is compressed. The second electrical conductor and the second inner wall twist, individually or in tandem, when the twinaxial electrical interposer is compressed. The first electrical conductor can include an opening that is configured to receive a first mating conductor. The second electrical conductor can include an opening that is configured to receive a second mating conductor. The first electrical conductor can include teeth that are configured to engage the first mating conductor when the twinaxial electrical interposer receives the first mating conductor. The second electrical conductor can include teeth that engage the second mating conductor when the twinaxial electrical interposer receives the second mating conductor.

An electrical interposer can include a first electrical conductor that can extend along a first longitudinal axis and can be configured to twist or spin or rotate about the first longitudinal axis when the first electrical conductor is compressed. The electrical interposer can further include a third electrical conductor that can extend along a second longitudinal axis, which can be parallel to the first longitudinal axis, and can be configured to twist for spin or rotate about the second longitudinal axis when the second electrical conductor is compressed. The first and third electrical conductors can independently twist or spin or rotate in the same directions. The first and third electrical conductors can independently twist or spin or rotate in opposite directions. The first and third electrical conductors can be coaxial or twinaxial signal contacts.

An electrical interposer can include a first electrical conductor that can extend along a first longitudinal axis. The first electrical connector can be repeatedly compressible in an end-to-end direction along the first longitudinal axis. An electrical insulator can circumscribe or at least partially circumscribe the first electrical conductor and can also be repeatedly compressible in the same end-to-end direction. A third electrical conductor can extend along a second longitudinal axis and can be repeatedly compressible in the end-to-end direction. The electrical insulator can circumscribe or at least partially circumscribe the third electrical conductor. The electrical insulator can also be repeatedly compressible in the same end-to-end direction. The first electrical conductor can twist or spin or rotate about the first longitudinal axis when the first electrical conductor is compressed. The third electrical conductor can twist or spin or rotate about the third longitudinal axis when the third electrical conductor is compressed. The first and third electrical conductors can twist or spin or rotate independently of one another. The first and third electrical conductors can twist or spin or rotate in the same directions. The first and third electrical conductors can twist or spin or rotate in opposite directions. The first electrical conductor can define a first opening that is configured to receive at least one of a mating conductor, a cable conductor, a press-fit tail, a solder tail, and a connector tail. The third electrical conductor can define a second opening that is configured to receive at least one of a mating conductor, a cable conductor, a press-fit tail, a solder tail, and a connector tail. The electrical interposer can further include a plurality of electrical interposers disposed in a flexible or rigid carrier and the plurality of electrical interposers can each be individually arranged in a matrix of rows and columns. The first electrical conductor can define a non-solid structure, such as a lattice structure. The third electrical conductor can define a non-solid structure, such as a lattice structure. The electrical insulator can define a non-solid structure, such as a lattice structure. The electrical interposer can be 3D printed. The electrical interposer and/or the first electrical conductor and/or the third electrical conductor and/or the electrical insulator can include a photopolymer.

A coaxial electrical interposer can include a repeatedly compressible first electrical conductor and a repeatedly compressible insulator. A twinaxial electrical interposer can include a repeatedly compressible first electrical conductor, a repeatedly compressible third electrical conductor and a repeatedly compressible insulator.

An electrical interposer can be compressible along a longitudinal axis and can include an electrical conductor and means for rotating at least a portion of the electrical conductor about the longitudinal axis.

The above and other features, elements, characteristics, steps, and advantages of the present invention will become more apparent from the following detailed description of the embodiments of the present invention with reference to the attached drawings.

### BRIEF DESCRIPTION OF THE DRAWINGS

FIG. 1 is a perspective view of an interposer with radial struts.

FIG. 2 is a top view of the interposer shown in FIG. 1.

FIGS. 3 and 4 are side and perspective views of a side cross-section of the interposer shown in FIG. 1.

FIGS. 5 and 6 are top and perspective views of a top cross-section of the interposer shown in FIG. 1.

FIG. 7 is a side view of a side cross-section of an interposer shown in FIG. 1 with caps on each end of the interposer.

FIGS. 8 and 9 are top and perspective views of an interposer with twisted inner struts and twisted outer struts.

FIGS. 10 and 11 are side and perspective views of a side cross-section of the interposer shown in FIGS. 8 and 9.

FIGS. 12A-12C are top and side views of a side cross-section of a center portion of the interposer shown in FIGS. 8 and 9.

FIGS. 13A-13C are side views of a side cross-section of a mating conductor being inserted into the interposer shown in FIGS. 8 and 9.

FIGS. 14 and 15 are top and perspective views of a twinaxial interposer.

FIGS. 16 and 17 are sectional views of the twinaxial interposer shown in FIGS. 14 and 15.

FIG. 18 shows a side cross-section of mating conductors being inserted into the twinaxial interposer shown in FIGS. 14 and 15.

FIGS. 19 and 20 are top and perspective views of the twinaxial interposer shown in FIGS. 14 and 15 with a cap.

FIG. 21 is an exploded view of the twinaxial interpose and cap shown in FIGS. 19 and 20.

FIG. 22 shows a carrier that can be used with the interposer of FIG. 1 or 8 or with the twinaxial interposer of FIG. 14.

### DETAILED DESCRIPTION

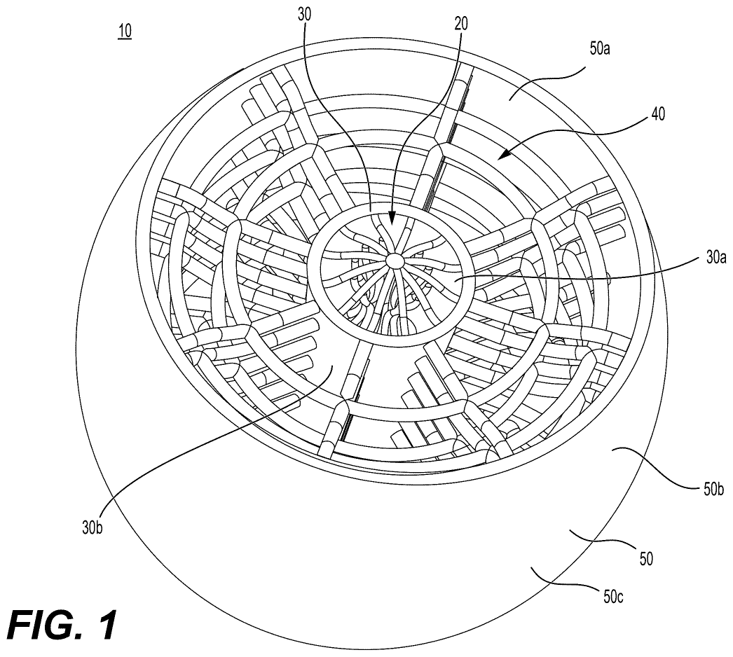

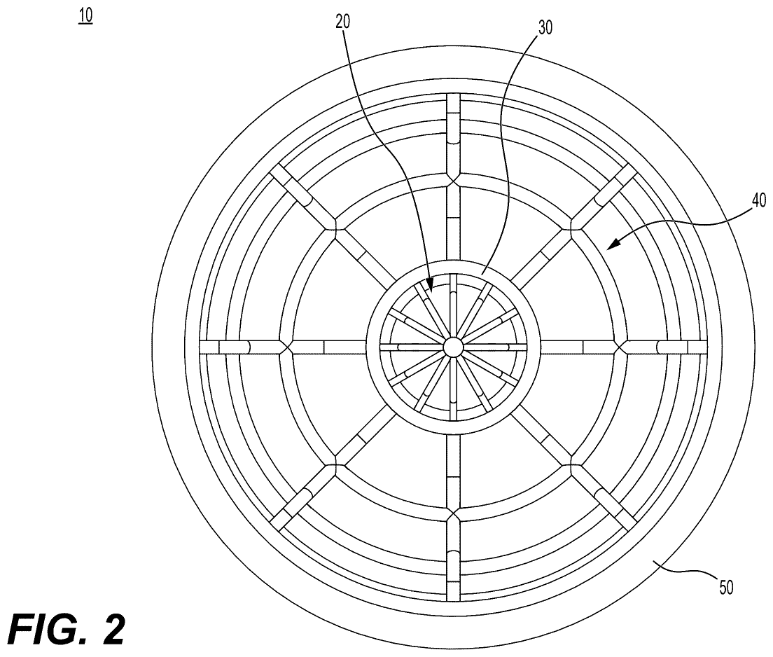

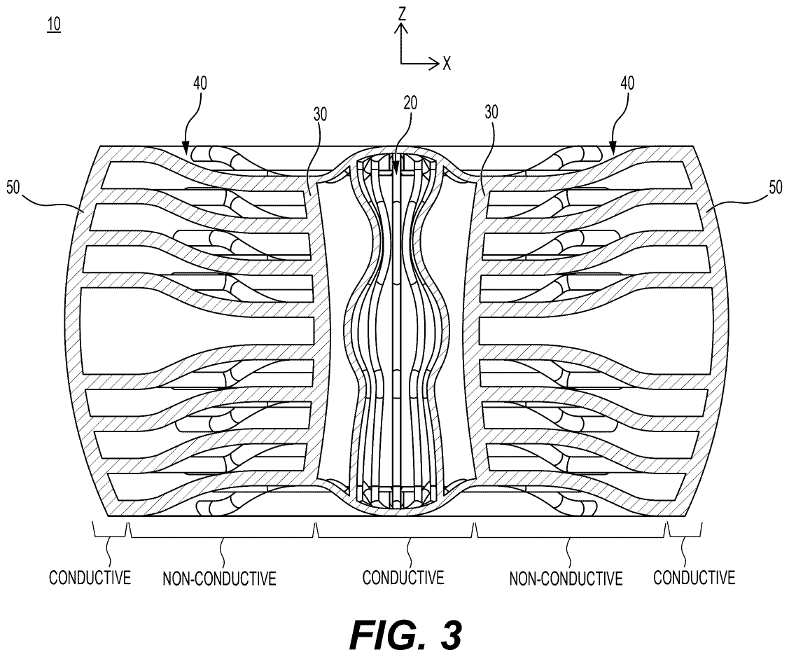

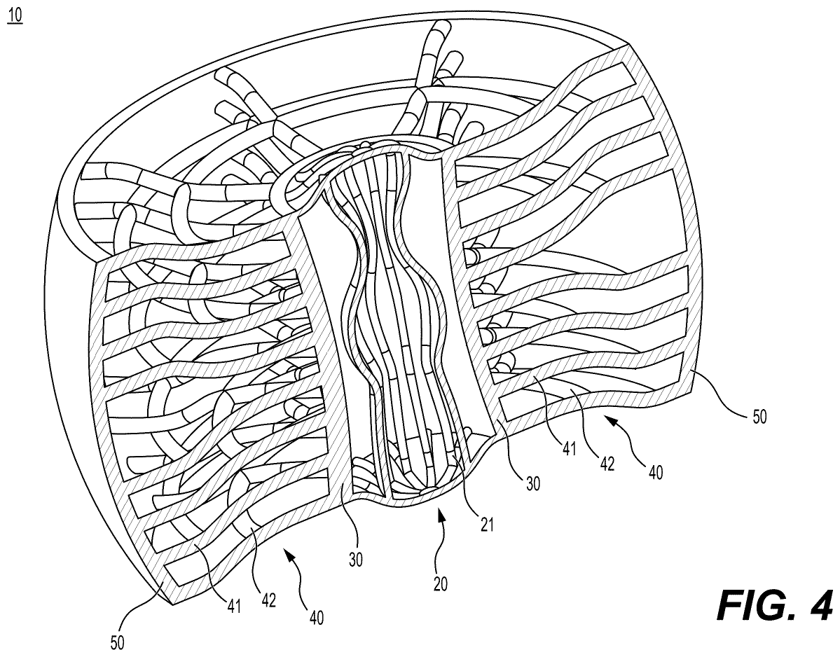

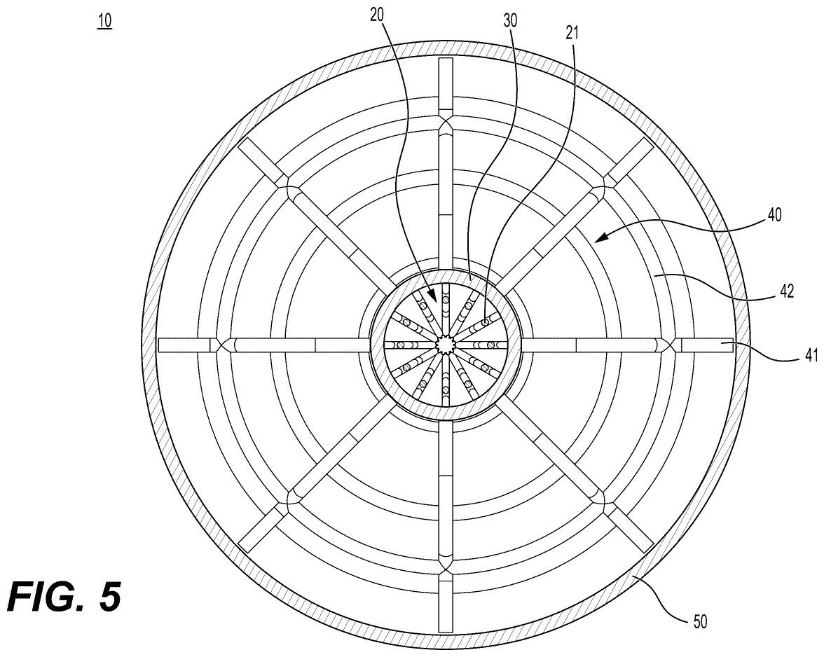

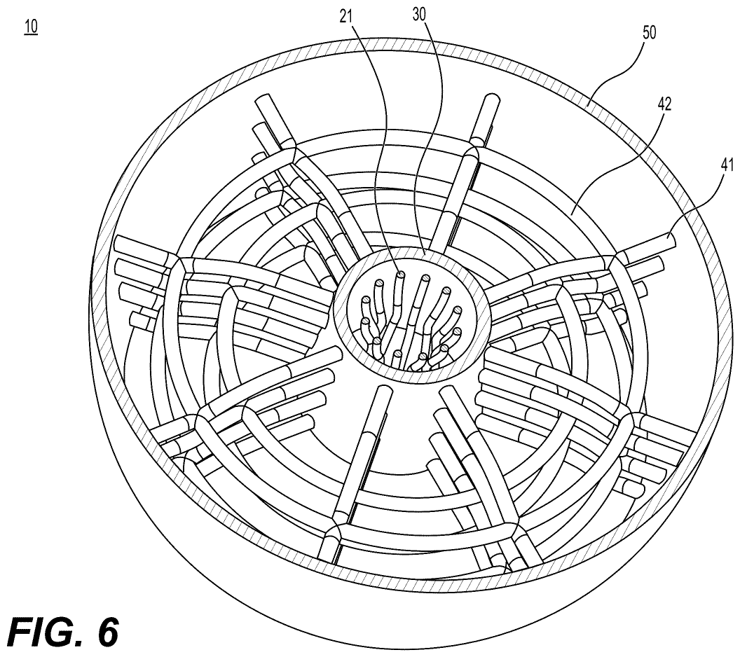

FIGS. 1-6 show an interposer 10 that includes an inner wall 30 with interior surface 30a and outer surface 30b, outer wall 50 with interior surface 50a and outer surface 50b, an electrical insulator 40, and an inner or first conductor 20. FIGS. 1 and 2 show perspective and top views of the interposer 10, FIGS. 3 and 4 show side and perspective views of a side cross-section of the interposer 10, and FIGS. 5 and 6 are top and perspective views of a top cross-section of the interposer 10.

As shown in FIGS. 1-6, the interposer 10 includes an inner wall 30 and an outer wall 50. Each of the inner wall 30 and the outer wall 50 may be structured in a tubular shape, with the inner wall 30 being circumscribed by the outer wall 50. The inner wall 30 and the outer wall 50 can be concentric. An inner or first electrical conductor 20 can be provided within the inner wall 30. The first electrical conductor 20 can extend along a first longitudinal axis and can be repeatedly compressible, in an end-to-end direction, along the first longitudinal axis or along a Z-direction (FIG. 3). An electrical insulator 40, for example, a dielectric material, can be provided between the inner wall 30 and the outer wall 50. The electrical insulator 40 can also be repeatedly compressible in the end-to-end direction. Repeatedly compressible can mean that when the interposer 10 is positioned on a substrate (not shown) such that the first electrical conductor 20 is positioned perpendicular to the substrate (not shown), and a force is applied to an end of the interposer 10 by a force mechanism (not shown), the interposer 10 compresses between the substrate (not shown) and the force mechanism (mechanism), such as in the Z-direction shown in FIG. 3 or along the first longitudinal axis, as to make an overall height of the interposer decrease in length. Alternatively, a force can be applied by the substrate (not shown) and the force mechanism can remain static or fixed or a combination of opposed forces can be generated simultaneously by the force mechanism (not shown) and a substrate (not shown). When the force is removed, the interposer 10 returns to its original, pre-compression height or within approximately 1-10% of its pre-compression height within measurement tolerances. Stated another way, the interposer 10 can be compressed and has an internal restorative force that prevents the interposer 10 and/or the inner or first electrical conductor 20 and/or the electrical insulator 40 from remaining permanently deformed after the interposer 10 and/or the inner and/or first conductor 20 or the electrical insulator 40 is compressed. Stated yet another way, the interposer 10 and/or first electrical conductor 20 and/or electrical insulator 40 can exhibit elastomeric or temporary deformation versus plastic or permanent deformation in response to a single direction compression force or opposed direction compression forces. The electrical interposer can include a polymer, such as a cured polymer or a cured photopolymer. The polymer, or cured polymer or cured photopolymer can be compressible in a longitudinal direction or can be longitudinally compressible.

Each of the inner or first electrical conductor 20 and the electrical insulator 40 can be defined by a non-solid structure, such as a lattice structure, that provides void spaces within the interposer 10 while providing mechanical rigidity of the interposer 10. The lattice structure of each of the inner or first electrical conductor 20 and the electrical insulator 40 can have radial symmetry about a center point of interposer 10 in the z-axis shown in FIG. 3. Any of the lattice structures discussed herein can be fortified or weakened to provide a desired level of repeatable or non-repeatable compressibility. At least one end of the first electrical conductor 20, or the inner wall 30, can rotate or twist or turn about a first longitudinal axis so to provide an alternative to wipe. That is, the lattice structure can provide a means for rotating the at least one end of the first electrical conductor 20 or inner wall 30. Rather than a traditional linear wipe, the first electrical conductor 20 or the inner wall 30 can provide a rotational or turning wipe to help remove or penetrate unwanted gunk, grime, debris, or oxidation. The rotating wipe end or ends of the first electrical conductor 20 can be further equipped with one or more teeth or a textured, sandpaper-like surface.

As shown in FIGS. 4-6, the inner or first electrical conductor 20 can include a plurality of inner struts 21, and the electrical insulator 40 can include a plurality of outer struts 41 and 42. The inner struts 21 can include a curved or waved shape to define areas of compression and expansion in the x-axis shown in FIG. 3 when a compression force is applied to the interposer 10 in the z-axis shown in FIG. 3. The inner struts 21 connecting the top and the bottom of the inner or first electrical conductor 20 can extend in a direction generally perpendicular to the outer struts 41 or in a longitudinal direction of the inner or first electrical conductor 20, i.e., the direction in which the interposer 10 is compressed. The electrical insulator 40 can include both radial outer struts 41 and circular or arced outer struts 42 to help maintain overall structural rigidity of the interposer 10 when a compression force is applied to the interposer 10 in the z-axis shown in FIG. 3. At least a portion of the radial outer struts 41 may extend fully between the inner wall 30 and the outer wall 50. The circular or arced outer struts 42 can be concentric with one or both of the inner wall 30 and the outer wall 50.

A structure of the inner struts 21 can be adjusted according to a mating connection to be provided, for example, to mate with a pad on a substrate or to receive a center conductor of a coaxial cable. A structure of the outer struts 41 and 42 can be adjusted to provide predetermined characteristics, for example, a predetermined dielectric constant, predetermined mechanical characteristics, or predetermined thermal characteristics.

The interposer 10 can be manufactured by additive manufacturing processes, for example, by a three-dimensional (3D) printing process. The interposer 10 can be made from a material or materials that can be deposited by a three-dimensional printing process. A base structure of each of the inner or first electrical conductor 20, the inner wall 30, the electrical insulator 40, and the outer wall 50 can be defined by an electrically non-conductive material, for example, plastic, or can be made from an electrically non-conductive, magnetic-absorbing material, for example, a ferro-magnetic ceramic. In particular, the interposer 10 can include a light-cured photopolymer resin that is able to be used in stereolithography (SLA) and digital light processing (DLP) processes. The light-cured photopolymer resin can be a thermoset polymer that has cross-linking induced by exposure to light of a predetermined frequency. The light-cured photopolymer resin may include photo-initiators that form a radical to initiate cross-linking, or may include thermoplastic polymers that do not have cross-linking. The additive manufacturing process can be implemented by a high-resolution 3D printer having a resolution of about 2 μm, for example, the MICROARCH S230 by BOSTON MICRO FABRICATION. However, 3D printers of other resolutions may be used, for example, a resolution on the order of about 200 nm.

The inner or first electrical conductor 20 and an interior surface 30a of the inner wall 30 can be coated or plated with an electrically conductive material, for example, copper and/or gold plating. Similarly, an outer surface 50b of the outer wall 50 can be coated with an electrically conductive material, for example, copper and/or gold plating. Approximate conductive and non-conductive regions of the interposer 10 are shown in FIG. 3. The conductive regions of the interposer 10 can be provided by a process that includes first chemically etching the inner or first electrical conductor 20, the interior surface 30a of the inner wall 30, and the outer surface 50b of the outer wall 50; and then subsequently electroplating each of the inner or first electrical conductor 20, the interior surface 30a of the inner wall 30, and the outer surface 50b of the outer wall 50.

The inner or first conductor 20 and the interior surface 30a of the inner wall 30 can define a first electrical conductor of the interposer 10. The outer surface 50b of the outer wall 50 can define a second electrical conductor 50c. The inner or first electrical conductor 20 can be a signal conductor, and the second electrical conductor 50c can be a ground conductor. The first electrical conductor and the second electrical conductor 50c can provide electrical connections between, for example, an RF connector and a mating substrate. Alternatively, the interposer 10 itself can define an RF connector.

A width of the interposer 10 in the x-axis can be about 4.5 mm within manufacturing and/or measurement tolerances, and a height of the interposer 10 in the z-axis can be about 2.5 mm within manufacturing and/or measurement tolerances. However, the dimensions of the interposer 10 are not limited and can be adjusted, for example, according to the application in which the interposer 10 is to be used.

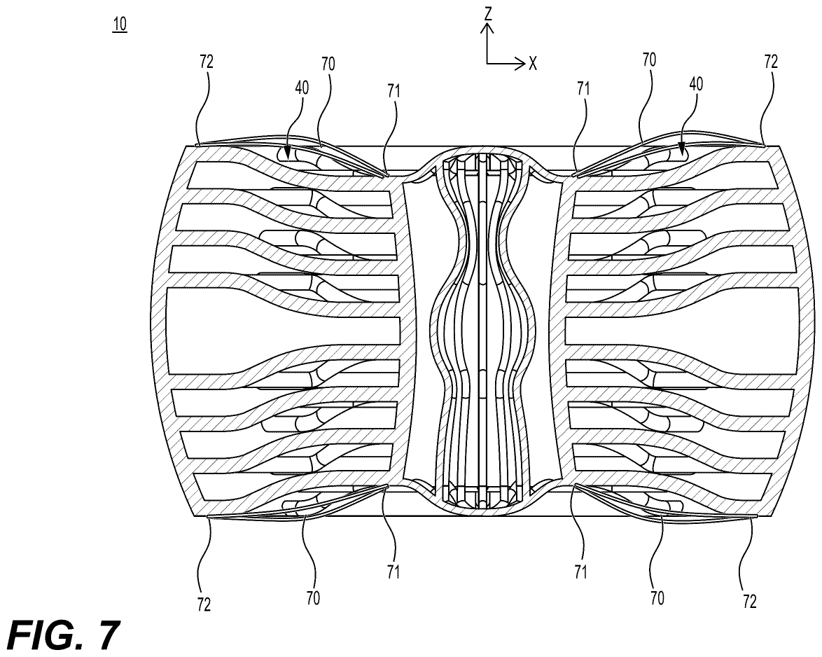

FIG. 7 is a side view of a side cross-section of the interposer 10 with lens caps 70. As shown in FIG. 7, the lens caps 70 can be provided to cover the electrical insulator 40 at each end of the interposer 10 in the z-axis direction. During a process of plating the inner or first electrical conductor 20, the interior surface 30a of the inner wall 30, and the outer surface 50b of the outer wall 50 with the electrically conductive material, the lens caps 70 can prevent the electrically conductive material from coating the electrical insulator 40.

Inner edges 71 and outer edges 72 of the lens caps 70 can include detachment features to help remove the lens caps 70 from the interposer 10 after the inner or first electrical conductor 20, the interior surface 30a of the inner wall 30, and the outer surface 50b of the outer wall 50 have been plated with the electrically conductive material. For example, the inner edges 71 and outer edges 72 of the lens caps 70 can include break-lines or areas with a reduced width or cross-section. Accordingly, the lens caps 70 can be removed by compressing the interposer 10 in the z-axis direction.

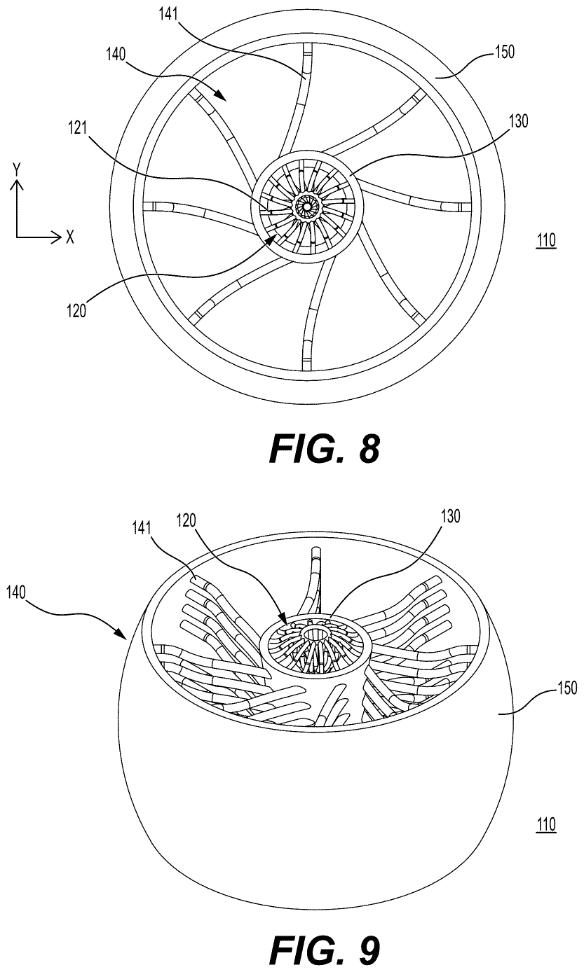

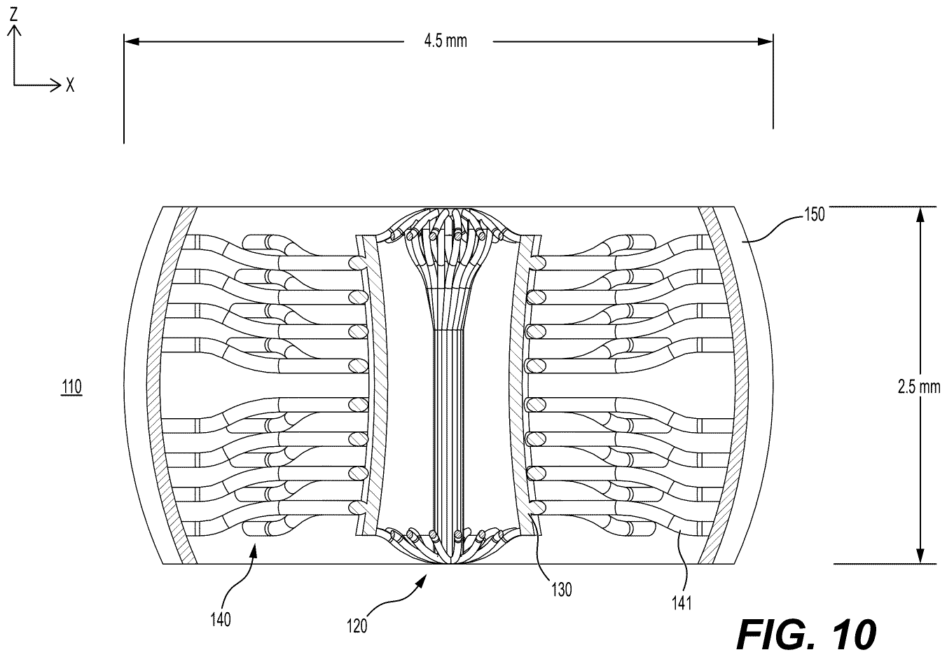

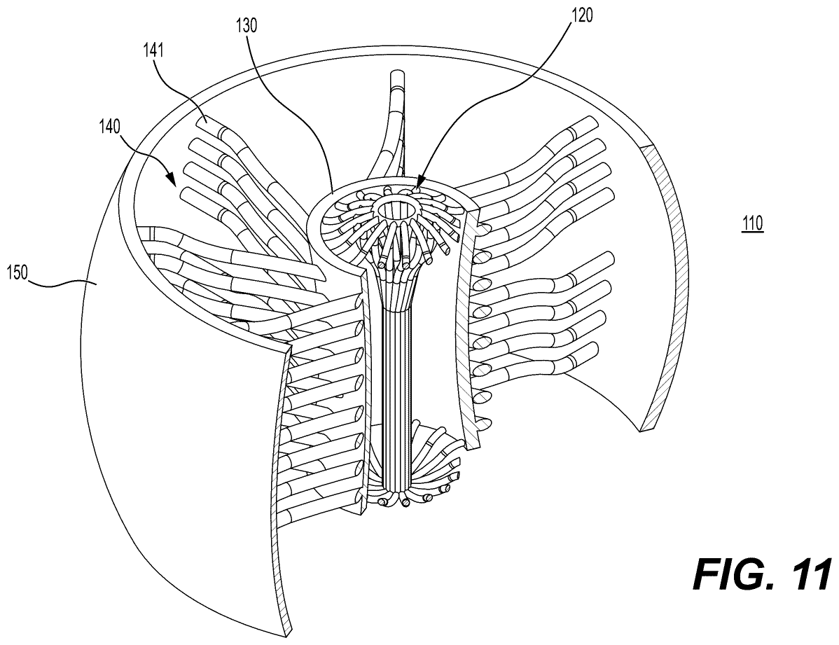

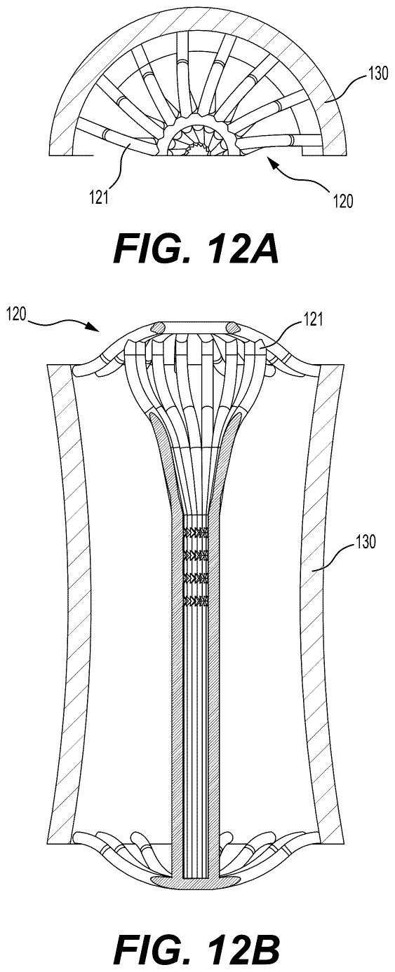

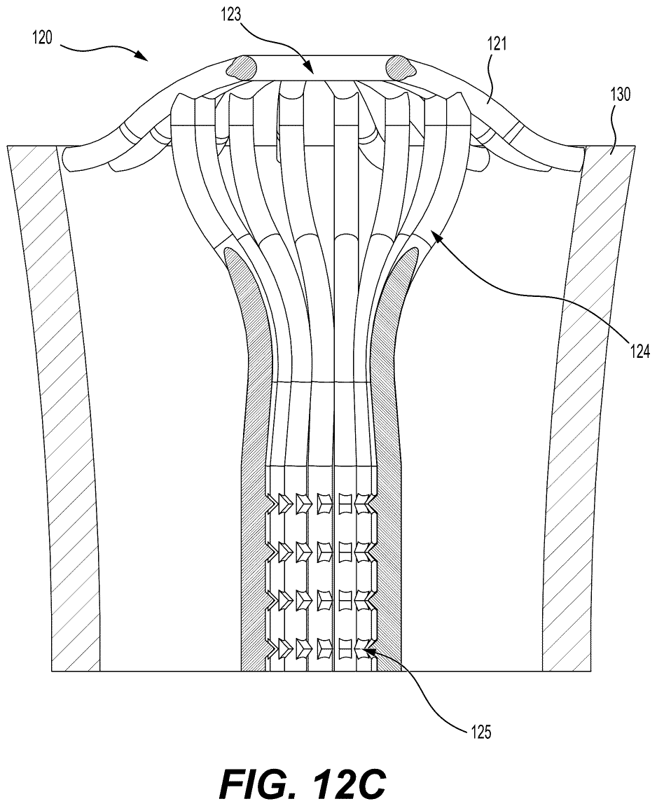

FIGS. 8-13C show an interposer 110 that includes inner struts 121 that are twisted and outer struts 141 that are twisted. FIGS. 8 and 9 are top and perspective views of the interposer 110. FIGS. 10 and 11 are side and perspective views of a side cross-section of the interposer 110. FIGS. 12A-12C are top and side views of a side cross-section of a center portion of the interposer 110.

Similar to the interposer 10 described above, the interposer 110 includes an inner wall 130 and an outer wall 150. Each of the inner wall 130 and the outer wall 150 may be structured in a tubular shape, with the inner wall 130 being circumscribed by the outer wall 150. An inner conductor 120 is provided within the inner wall 130. An electrical insulator 140, for example, a dielectric material, is provided between the inner wall 130 and the outer wall 150.

However, unlike the interposer 10, the inner or first electrical conductor 120 can include a plurality of inner struts 121 that are provided in a twisted pattern or in a spiral, radial pattern. The inner struts 121 can have a curved shape in plan view, as shown in FIGS. 8 and 12A. As shown in FIG. 12C, the inner or first electrical conductor 120 can include an opening 123 and a tapered portion 124. In addition, the inner struts 121 can include teeth or barbs 125.

Similar to the inner or first electrical conductor 120, the electrical insulator 140 can include a plurality of outer struts 141 that are provided in a twisted pattern or in a spiral, radial pattern. The outer struts 141 can also have a curved shape in plan view, as shown in FIG. 8. The electrical insulator 140 may not include curved or arced outer struts that are concentric with the inner wall 130 and the outer wall 150.

By providing both the inner struts 121 and the outer struts 141 with a twisted pattern or a spiral, radial pattern, the interposer 110 can maintain a location of the center point of the inner or first electrical conductor 120 in both the x-axis and the y-axis shown in FIG. 8. In addition, the twisted pattern or the spiral, radial pattern can help grasp and secure a mating conductor, as will be described below. The mating conductor can be any suitable mating conductor, including, for example, a cable conductor, a press-fit tail, a solder tail, a connector tail, etc. That is, the structure of the inner struts 121 and outer struts 141 provides rigidity in the x-axis and y-axis to maintain the location of the inner or first electrical conductor 120, while also providing elasticity in the z-axis to provide a robust and reliable connection with the mating conductor.

As shown in FIG. 10, a width of the interposer 110 in the x-axis can be about 4.5 mm within manufacturing and/or measurement tolerances, and a height of the interposer 110 in the z-axis can be about 2.5 mm within manufacturing and/or measurement tolerances. However, the dimensions of the interposer 110 are not limited and can be adjusted, for example, according to the application in which the interposer 110 is to be used.

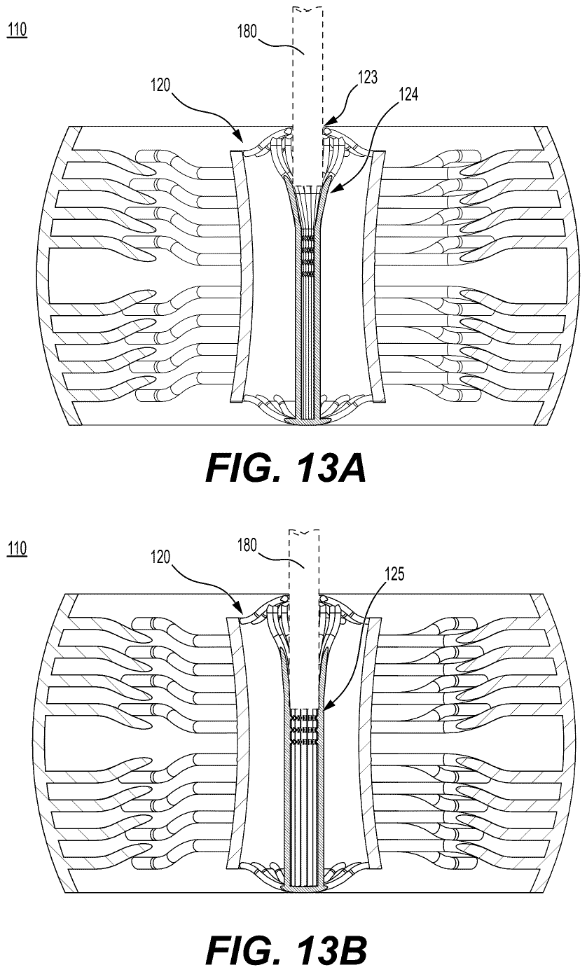

FIGS. 13A-13C are side views of a side cross-section of a mating conductor 180 being inserted into the interposer 110.

As shown in FIG. 13A, a mating conductor 180 can first be inserted into the opening 123 of the inner or first electrical conductor 120. The mating conductor 180 is then received by the tapered portion 124 to guide and to locate the mating conductor 180 to the center position of the interposer 110 in both the x-axis and the y-axis shown in FIG. 8. The mating conductor 180 can be any suitable mating conductor, including, for example, a cable conductor, a press-fit tail, a solder tail, a connector tail, etc.

As shown in FIG. 13B, as the mating conductor 180 is further inserted into the inner conductor 120, the mating conductor 180 is received by the teeth or barbs 125. The teeth or barbs 125 help to grasp and secure the mating conductor 180 within the interposer 110. The teeth or barbs 125 can also provide improved conductivity between the mating conductor 180 and the inner or first electrical conductor 120 by providing multiple physical and electrical connections between the mating conductor 180 and the inner or first electrical conductor 120.

As shown in FIG. 13C, the mating conductor 180 can include a roughened surface 185, for example, scoring, to further help secure the mating conductor 180 within the interposer 110 and to further provide improved conductivity between the mating conductor 180 and the inner or first electrical conductor 120.

As the mating conductor 180 is still further inserted into the interposer 110, the interposer 110 may be compressed in the z-axis shown in FIG. 10. As the interposer 110 is compressed, the twisted pattern or the radial, spiral pattern of the inner struts 121 and the outer struts 141 generates a twisting force that maintains the location of center point of the inner conductor 120 in both the x-axis and the y-axis shown in FIG. 8 and also tightens the inner of first electrical conductor 120 around the mating conductor 180. Thus, the twisted pattern or the radial, spiral pattern of the inner struts 121 and the outer struts 141 can further help secure the mating conductor 180 within the interposer 110 and to further provide improved conductivity between the mating conductor 180 and the inner or first electrical conductor 120.

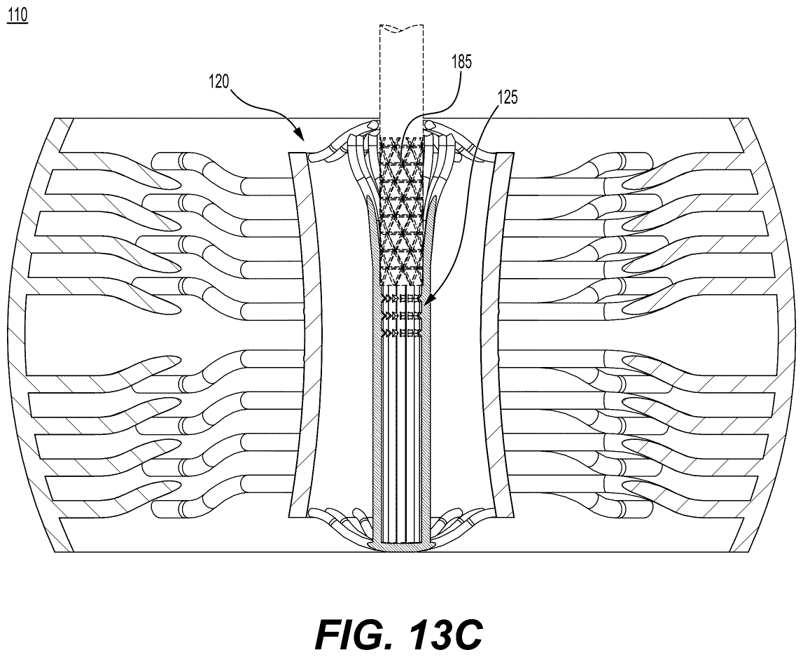

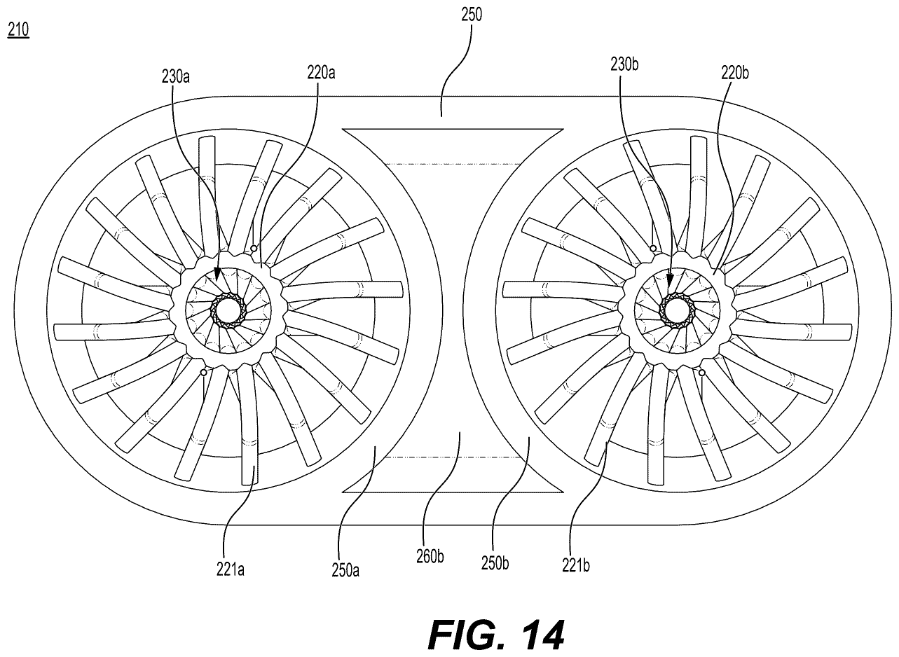

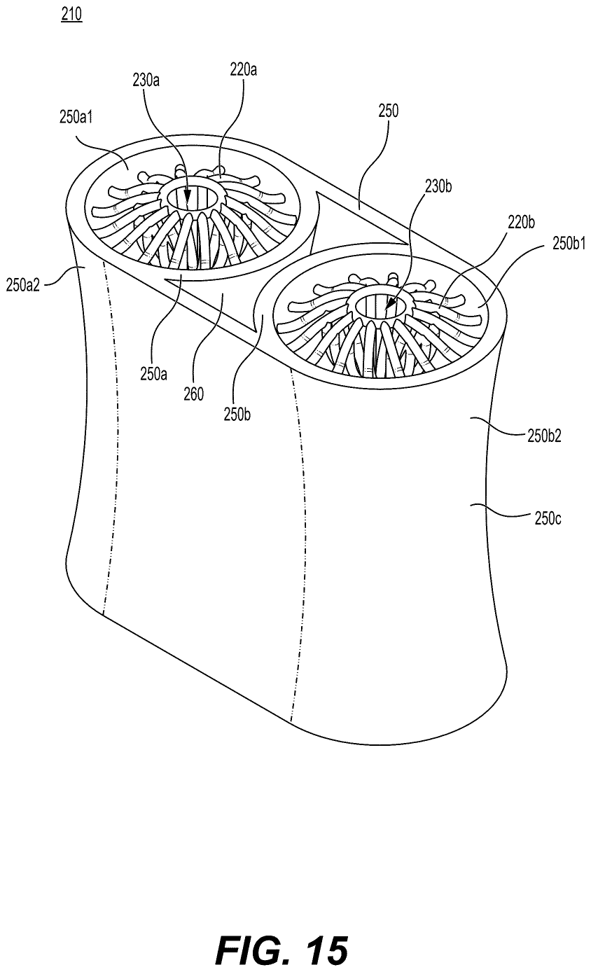

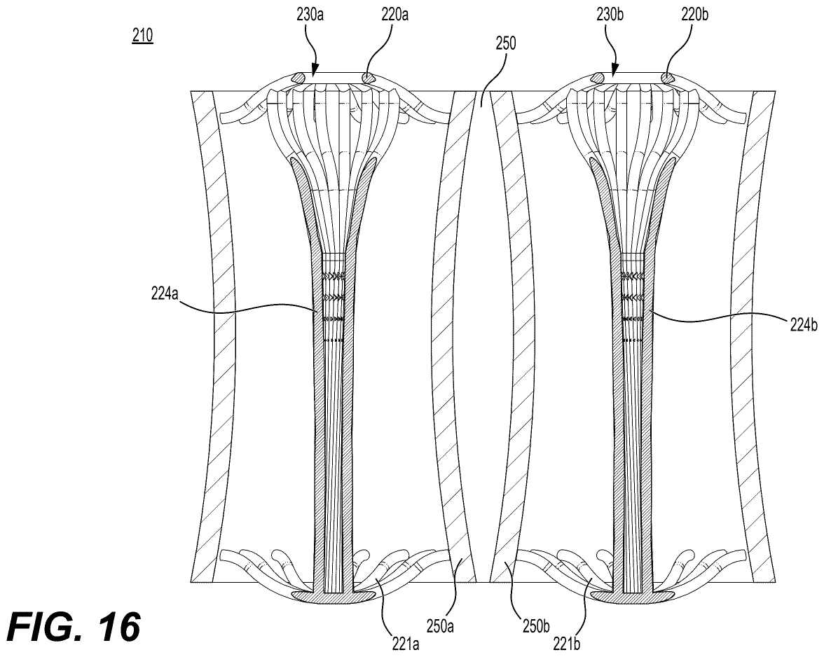

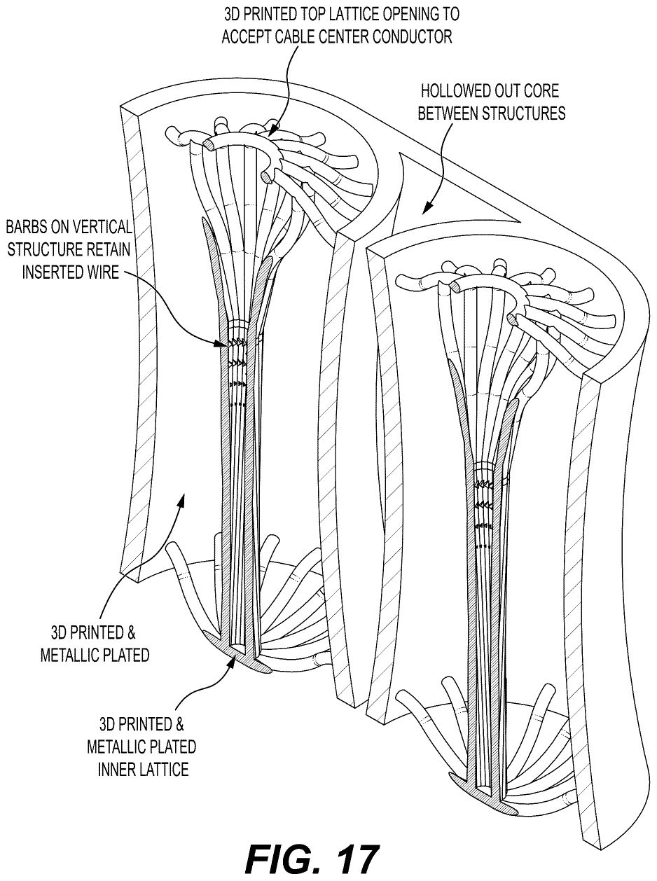

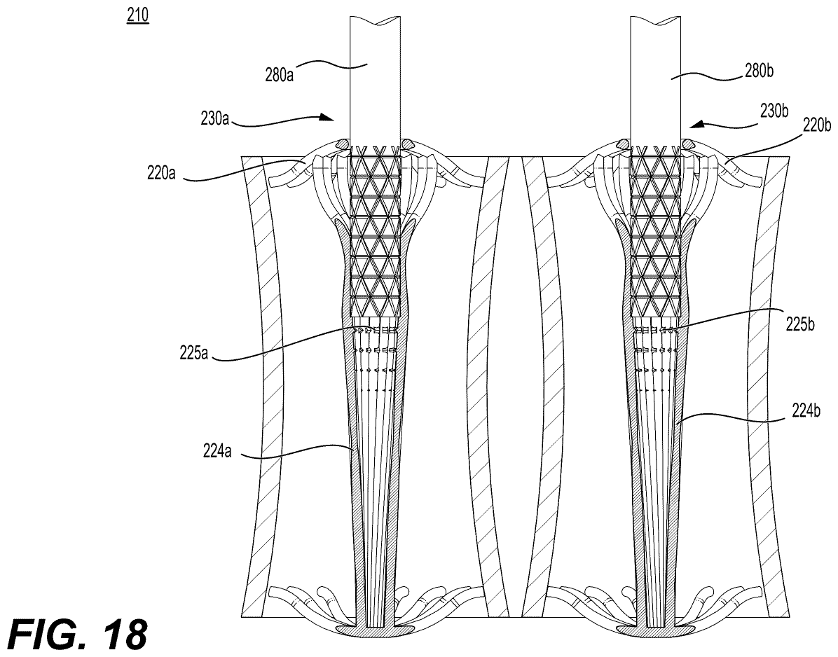

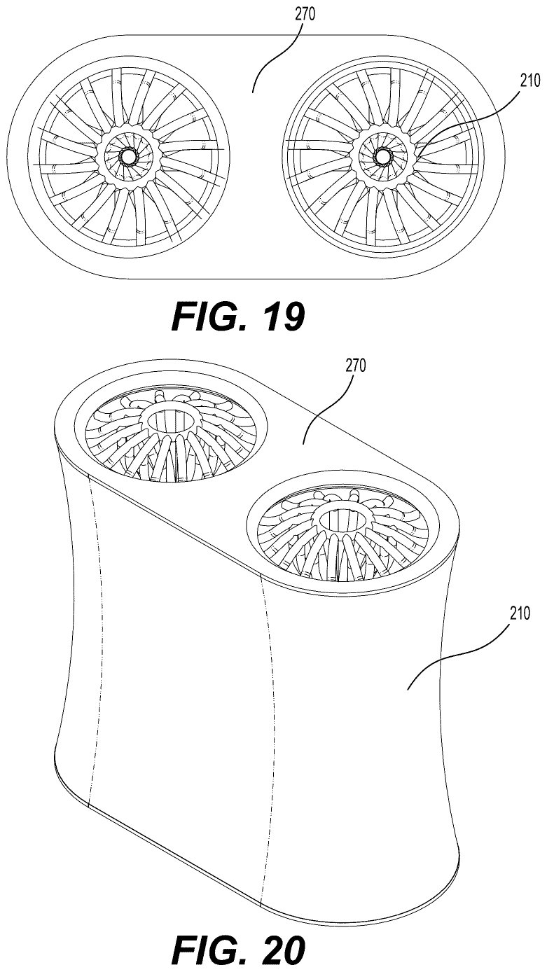

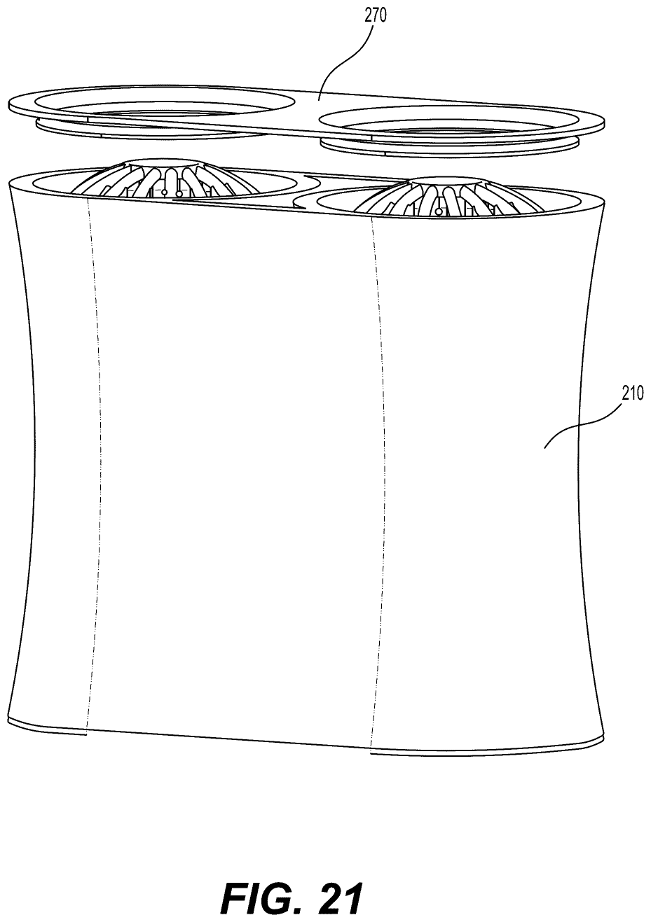

FIGS. 14-18 show a twinaxial interposer 210 that includes two interposers that share a common outer wall 250. The twinaxial interposer 210 includes a space 260 between the two interposers that can be covered by a cap 270 as shown in FIGS. 19-21. FIGS. 14 and 15 are top and perspective views of a twinaxial interposer. FIGS. 16 and 17 are sectional views of the twinaxial interposer shown in FIGS. 14 and 15. FIG. 18 shows a side cross-section of a mating conductor 180 being instead into the twinaxial interposer shown in FIGS. 14 and 15. Although FIGS. 14-18 shows two interposers, it is possible include more than two interposers within a single outer wall.

The twinaxial interposer 210 includes a first outer wall 250a with an interior surface 250a1 and an outer surface 250a2, a first inner or first electrical conductor 220a with an opening 230a at the top of the first inner conductor 220a, a second outer wall 250b with an interior surface 250b1 and an outer surface 250b2, and a third inner or third electrical conductor 220b with opening 230b at the top of the third inner or third electrical conductor 220b, where the first and the second outer walls 250a, 250b are included in the outer wall 250. A second electrical conductor 250c can be disposed on the outer surface of the outer wall 250. The first and the third inner or the first and third electrical conductors 220a, 220b can include struts 221a, 221b that are connected to the first and the second outer walls 250a, 250b. The tapered portions 224a, 224b can include struts that extend in a longitudinal direction of the twinaxial interposer 210 or a direction in which the twinaxial interposer 210 is compressed. At least one end of each of the first inner or first electrical conductor 220a and the third inner or third electrical conductor 220b can rotate or twist or turn about a first longitudinal axis so to provide an alternative to wipe, rather than a traditional linear wipe, to help remove or penetrate unwanted gunk, grime, debris, or oxidation. The first inner or first electrical conductor 220a and the third inner or third electrical conductor 220b can rotate in the same direction or can rotate in opposite directions. That is, the struts 221a, 221b can provide means for rotating the at least one end of each of the first inner or first electrical conductor 220a and the third inner or third electrical conductor 220b. Alternatively, the twinaxial interposer 210 can include two interposers similar to the interposers 10, 110 shown in FIGS. 1 and 10 joined by a common wall similar to the common wall 250.

The twinaxial interposer 210 can be selectively metallized. The first and third inner or first and third electrical conductors 240a, 240b and the outer surface of the outer wall 250 can be made conductive by applying a metal layer to the inner conductors 240a, 240b and the outer surface of the outer wall 250. For example, as shown in FIGS. 19-21, the twinaxial interposer 210 includes caps 270 at each of the twinaxial interposer 210. The twinaxial interposer 210 can be made with caps 270 to cover the top and the bottom surfaces of the outer wall 250 and the space 260, or the caps 270 can be added to the twinaxial interposer 210 to cover the top and the bottom surfaces of the outer wall 250 and the space 260. Then, an electrically conductive material can be selectively applied to the twinaxial interposer 210. No electrically conductive material can be applied to outer surfaces of the first and the second outer walls 250a, 250b within the space 260 or on the top and the bottom surfaces of the outer wall 250. For example, a metal layer can be plated on the first and the third inner or the first and third electrical conductors 240a, 240b and the outer surface of the outer wall 250. After selective metallization, the caps 270 can be removed. The caps 270 can include detachment features to help remove the caps 270 from the interposer 210. For example, the edges of the caps 270 can include break-lines or areas with a reduced width or cross-section. The caps 270 can be removed by compressing the interposer 210 in the z-axis direction.

As shown in FIG. 18, mating conductors 280a, 280b can first be inserted into the openings 230a, 230b at the top of the inner or first and/or third electrical conductors 220a, 220b. It is also possible to include openings at the bottom of the first and third inner or first and third electrical conductors 220a, 220b so that additional mating conductors can be inserted into the twinaxial interposer 210. As shown in FIG. 18, the mating conductors 280a, 280b are then received by the tapered portions 224a, 224b to guide and to locate the mating conductors 280a, 280b to the center positions of each of the two interposers. The teeth or barbs 225a, 225b help to grasp and secure the mating conductors 280a, 280b within the twinaxial interposer 210. The teeth or barbs 225a, 225b can also provide improved conductivity between the mating conductors 280a, 280b and the first and third inner or electrical conductors 220a, 220b by providing multiple physical and electrical connections between the mating conductors 280a, 280b and the first and third inner or first and third electrical conductors 220a, 220b.

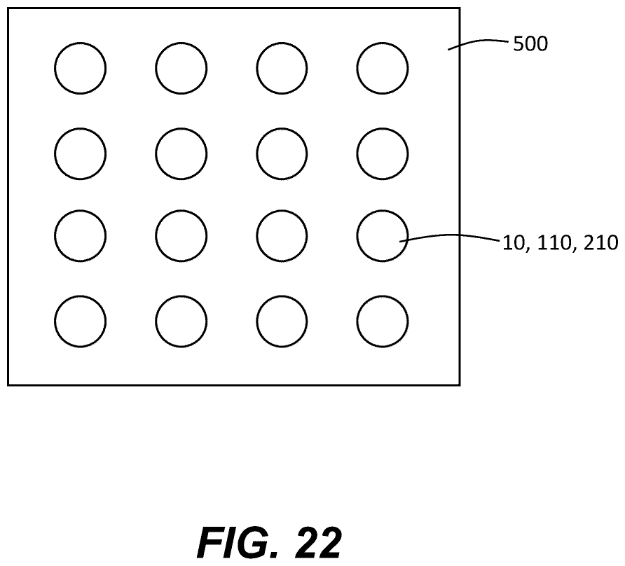

The interposers 10 and 110 and the twinaxial interposer 210 can be included in a carrier 500 as shown in FIG. 22. The carrier 500 can be rigid or flexible. Both the carrier 500 and the interposers 10, 110 or the twinaxial interposers 210 can be manufactured using additive manufacturing, including, for example, 3D printing. Both the carrier 500 and the interposers 10, 110 or the twinaxial interposers 210 can be printed using additive manufacturing during the same print cycle or print period or print operation. A print cycle can include a time period that starts when printing starts and ends when a part or object has been printed, e.g., the carrier 500 with the array of interposers 10, 110 or twinaxial interposers 210. Alternatively, the carrier 500 and the interposers 10, 110 or twinaxial interposers 210 can be manufactured separately and then combined in a different step. In FIG. 22, sixteen interposers 10, 110 or twinaxial interposers 210 are included in a 4×4 array, but any number and any arrangement of interposers 10 can be used.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1: An electrical interposer comprising:
an electrical conductor;
an inner wall that circumscribes the electrical conductor and that includes an outer surface and an inner surface;
an outer wall that circumscribes the inner wall and that includes an outer surface and an inner surface; and
a connecting structure between the inner wall and the outer wall, wherein
the electrical conductor and the inner wall twist when the electrical interposer is compressed.

2: The electrical interposer according to claim 1, wherein each of the inner wall and the outer wall has a tubular shape.

3: The electrical interposer according to claim 2, wherein the inner wall and the outer wall are concentric.

4: The electrical interposer according to claim 1, wherein the connecting structure is not electrically conductive.

5: The electrical interposer according to claim 1, wherein the electrical conductor is defined by a lattice structure that includes void spaces and struts extending from the outer surface of the inner wall.

6: The electrical interposer according to claim 1, wherein the connecting structure is defined by a lattice structure that includes void spaces and struts extending from and between the outer surface of the inner wall and the inner surface of the outer wall.

7: The electrical interposer according to claim 1, wherein the electrical conductor includes an opening that receives a mating conductor.

8: The electrical interposer according to claim 1, wherein each of the electrical conductor, the inner wall, the outer wall, and the connecting structure includes a same material.

9: The electrical interposer according to claim 8, wherein the material of each of the electrical conductor, the inner wall, the outer wall, and the connecting structure includes a 3D-printed material.

10: The electrical interposer according to claim 1, wherein the electrical conductor includes an electrically conductive coating.

11: The electrical interposer according to claim 1, wherein the inner surface of the inner wall includes an electrically conductive coating.

12: The electrical interposer according to claim 1, wherein the outer surface of the outer wall includes an electrically conductive coating.

13: The electrical interposer according to claim 5, wherein the struts are arranged in a twisted pattern or in a radial, spiral pattern.

14. (canceled)

15: The electrical interposer according to claim 13, wherein the electrical conductor includes an opening to receive a mating conductor.

16: The electrical interposer according to claim 15, wherein the electrical conductor include teeth that engage the mating conductor when the electrical interposer receives the mating conductor.

17-55. (canceled)

56: An electrical interposer comprising first electrical conductor that extends along a first longitudinal axis and twists or spins or rotates about the first longitudinal axis when the first electrical conductor is compressed.

57: An electrical interposer of claim 56, further comprising a third electrical conductor that extends along a second longitudinal axis and twists for spins or rotates about the second longitudinal axis when the third electrical conductor is compressed.

58: The electrical interposer of claim 57, wherein the first and the third electrical conductors twist or spin or rotate in a same direction.

59: The electrical interposer of claim 57, wherein the first and the third electrical conductors twist or spin or rotate in opposite directions.

60: An electrical interposer that is compressible along a longitudinal axis comprising an electrical conductor and means for rotating at least a portion of the electrical conductor about the longitudinal axis.

61: The electrical interposer of claim 60, wherein the electrical interposer includes a cured polymer or a cured photopolymer.
